(19) United States
(12) Patent Application Publication
(10) Pub. No.: US 2026/0349545 A1
(43) Pub. Date: Nov. 5, 2026

(54) SIGNAL GENERATION CIRCUIT, TOUCH CONTROLLER CHIP, AND ACTIVE STYLUS

(71) Applicant: SHENZHEN GOODIX TECHNOLOGY CO., LTD., Shenzhen (CN)

(72) Inventors: Mengyi HUANG, Shenzhen (CN); Le ZHANG, Shenzhen (CN); Fujian YI, Shenzhen (CN)

(73) Assignee: SHENZHEN GOODIX TECHNOLOGY CO., LTD., Shenzhen (CN)

(21) Appl. No.: 19/707,039

(22) Filed: Jun. 12, 2026

Related U.S. Application Data
(63) Continuation of application No. PCT/CN2024/077982, filed on Feb. 21, 2024.

(51) Int. Cl. G06F 3/038; G06F 3/0354; G06F 3/044; H02M 1/088; H02M 3/07

(52) U.S. Cl. CPC G06F 3/0383; G06F 3/03545; G06F 3/0442; H02M 1/088; H02M 3/07

(57) ABSTRACT

A signal generation circuit, a chip and an active stylus are provided. The signal generation circuit includes a voltage boost circuit, a charge pump and a driving circuit; an input end of the voltage boost circuit is connected to a power supply, an output end of the voltage boost circuit is connected to an input end of the charge pump, and an output end of the charge pump is connected to the driving circuit; the voltage boost circuit is configured to boost a power supply voltage provided by the power supply to a preset voltage; the charge pump is configured to increase the preset voltage by a preset integer multiple to generate a target voltage; and the driving circuit is configured to receive the target voltage, and generate a driving signal at least based on the target voltage.

### CROSS REFERENCE TO RELATED APPLICATIONS

This application is a continuation of International Application No. PCT/CN2024/077982 filed on Feb. 21, 2024, entitled “Signal generation circuit, touch controller chip, and active stylus”. The contents of which is incorporated herein by reference in its entirety.

### TECHNICAL FIELD

Embodiments of the present disclosure relate to the field of touch control technology, and in particular, to a signal generation circuit, a touch controller chip, and an active stylus.

### BACKGROUND

With the development of touch control technology and mobile terminal technology, an increasing number of mobile terminals adopt a touch control mode for human-computer interaction. At present, touch screens adopted by mobile terminals are mainly capacitive touch screens. A capacitive touch screen not only supports direct touch operation with a finger, but also allows touch operation by means of an active touch stylus (hereinafter referred to as an active stylus) instead of a finger. When a touch operation is performed by using an active stylus, the active stylus usually needs to output a relatively high encoding voltage to realize communication between the active stylus and a terminal device.

In the related art, a boost chopper circuit (also referred to as a Boost circuit) is generally used in an active stylus to boost a low power supply voltage to a high target voltage, so as to provide a high encoding voltage. This requires devices in the Boost circuit to withstand a high withstand voltage, which increases device costs. In addition, since a voltage gain is high when the Boost circuit performs voltage boosting, while a load current is usually very low in active stylus applications, the boosting efficiency of the Boost circuit is low, resulting in low overall operating efficiency of the entire circuit.

### SUMMARY

In view of this, embodiments of the present disclosure aim to provide a signal generation circuit, a touch controller chip and an active stylus, which can at least partially solve the above technical problems.

In a first aspect, embodiments of the present disclosure provide a signal generation circuit, including: a voltage boost circuit, a charge pump and a driving circuit. An input end of the voltage boost circuit is connected to a power supply, an output end of the voltage boost circuit is connected to an input end of the charge pump, and an output end of the charge pump is connected to the driving circuit. The voltage boost circuit is configured to boost a power supply voltage provided by the power supply to a preset voltage; the charge pump is configured to increase the preset voltage by a preset integer multiple to generate a target voltage; and the driving circuit is configured to receive the target voltage, and generate a driving signal at least based on the target voltage.

In a second aspect, embodiments of the present disclosure further provide a touch controller chip, including the signal generation circuit provided in the first aspect.

In a third aspect, embodiments of the present disclosure further provide an active stylus, including the touch controller chip provided in the second aspect.

In the technical solution provided by the embodiments of the present disclosure, the voltage boost circuit serves as a first-stage boost to increase the power supply voltage to the preset voltage, and the charge pump serves as a second-stage boost to further increase the preset voltage to the target voltage for supply to the driving circuit. By adopting the voltage boost circuit and the charge pump to implement two-stage voltage boosting, the requirement on a withstand voltage of devices in the voltage boost circuit and the charge pump is greatly reduced, compared with a single-stage boosting solution using only a Boost circuit in the related art, thereby reducing design and application costs of the signal generation circuit. In addition, with the adoption of the charge pump, an output voltage of the voltage boost circuit is the preset voltage lower than the target voltage, so that a voltage multiplication factor of the voltage boost circuit may be relatively low. Correspondingly, the boosting efficiency of the voltage boost circuit is improved. Meanwhile, the charge pump features low path loss and high efficiency. Therefore, the signal generation circuit provided by the present disclosure may achieve both low design and application costs and high operating efficiency.

### BRIEF DESCRIPTION OF DRAWINGS

Hereinafter, some specific embodiments of the embodiments of the present disclosure will be described in detail with reference to the accompanying drawings in an exemplary and non-limiting manner. The same reference numerals in the accompanying drawings indicate the same or similar components or parts. Those skilled in the art should understand that the accompanying drawings are not necessarily drawn to scale. In the accompanying drawings:

FIG. 1 is a schematic structural diagram of a signal generation circuit provided by the related art;

FIG. 2 is a schematic structural diagram of a signal generation circuit provided by an embodiment of the present disclosure;

FIG. 3 is a circuit structural diagram of a signal generation circuit provided by an embodiment of the present disclosure;

FIG. 4 is a circuit structural diagram of a signal generation circuit provided by an embodiment of the present disclosure;

FIG. 5 is a circuit structural diagram of a signal generation circuit provided by an embodiment of the present disclosure;

FIG. 6 is a circuit structural diagram of a signal generation circuit provided by an embodiment of the present disclosure;

FIG. 7 is a schematic diagram of a driving signal of the signal generation circuit provided by an embodiment of the present disclosure;

FIG. 8 is a schematic structural diagram of a signal generation circuit provided by an embodiment of the present disclosure;

FIG. 9 is a schematic diagram of a driving signal of the signal generation circuit provided by an embodiment of the present disclosure;

FIG. 10 is a circuit structural diagram of a signal generation circuit provided by an embodiment of the present disclosure; and

FIG. 11 is a circuit structural diagram of a signal generation circuit provided by an embodiment of the present disclosure.

### DETAILED DESCRIPTION

In order to enable those in this art to better understand the technical solution in embodiments of the present disclosure, the technical solution in the embodiments of the present disclosure will be described clearly and completely in the following in conjunction with the accompanying drawings in the embodiments of the present disclosure. It is obvious that the described embodiments are only some of the embodiments in the embodiments of the present disclosure, but not all of the embodiments. Based on the embodiments of the present disclosure, all other embodiments obtained by those of ordinary skill in the art shall fall within the scope of protection of the embodiments of the present disclosure.

Capacitive touch screens are widely adopted as touch screens for mobile terminals due to their favorable definition, light transmittance and touch feeling. A capacitive touch screen not only supports direct touch operation with a finger, but also allows touch operation by means of an active touch stylus (hereinafter referred to as an active stylus) instead of a finger. In application scenarios where an active stylus is used in cooperation with a terminal device, the active stylus is configured to perform writing or inputting instructions to the terminal device equipped with a capacitive touch screen, such as a mobile terminal device, a computer screen, a drawing tablet and the like, so as to realize human-computer interaction. To realize communication between the active stylus and the terminal device, the active stylus needs to output a driving signal. the driving signal is usually a high-voltage signal, so as to ensure that a communication signal between the active stylus and the terminal device has a high signal-to-noise ratio. To enable the active stylus to output such a driving signal, a signal generation circuit in the active stylus needs to boost a power supply voltage provided by a power supply to a target voltage, generate the driving signal based on the target voltage, and supply the driving signal to the active stylus (for example, a nib of the active stylus) for output by the active stylus.

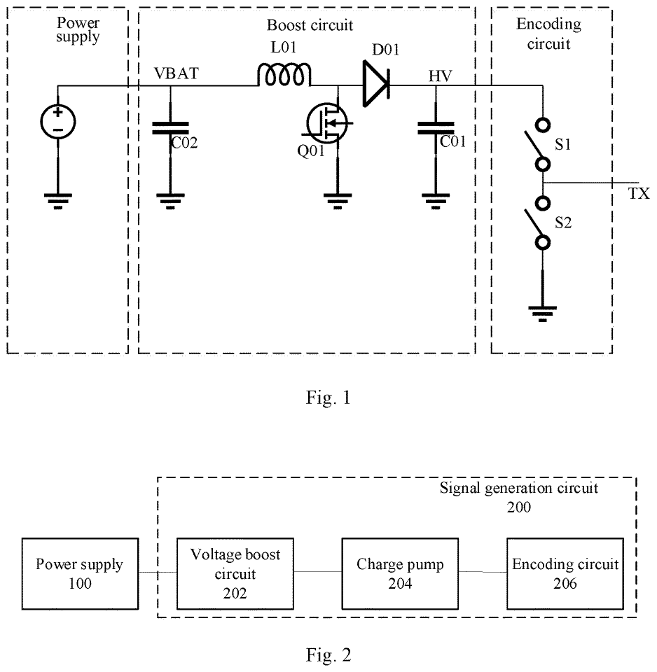

FIG. 1 is a schematic structural diagram of a signal generation circuit provided by the related art. As shown in FIG. 1, the signal generation circuit includes a Boost circuit and a driving circuit. An input end of the Boost circuit is connected to a power supply (also referred to as an input power supply), to receive a power supply voltage from the input power supply, and directly convert the power supply voltage into a desired DC voltage (i.e., a target voltage) to be supplied to the driving circuit. The input power supply typically provides a relatively low DC voltage, for example, the power supply voltage of the input power supply usually ranges from 1.0 V to 5 V. The target voltage is typically a relatively high DC voltage, which may be 60 V, 40 V, or 20 V, for example. An input end of the driving circuit is connected to an output end of the Boost circuit, and an output end of the driving circuit is connected to a driving electrode, which is typically disposed in a nib of the active stylus. The driving circuit generates a driving signal based on the target voltage and provides the driving signal to the driving electrode.

In the signal generation circuit shown in FIG. 1, the Boost circuit is used to directly boost the power supply voltage into the target voltage. The Boost circuit includes an inductor L01, a main power transistor Q01, a freewheeling diode D01, and a capacitor C01. A first terminal of the inductor L01 is connected to the power supply, where the power supply may be a battery and provide the power supply voltage V (also referred to as VBAT). A second terminal of the inductor L01 is connected to a first terminal of the main power transistor Q01 and the anode of the freewheeling diode D01. A second terminal of the main power transistor Q01 is connected to the ground, and a third terminal of the main power transistor Q01 is connected to a control module (not shown) to receive a control signal. The cathode of the freewheeling diode D01 is connected to the input end of the driving circuit and a first terminal of the capacitor C01, and a second terminal of the capacitor C01 is connected to the ground.

The inductor L01 and the main power transistor Q01 form a basic energy conversion unit. When the main power transistor Q01 is turned on, the inductor L01 is charged, and the energy stored in the inductor L01 increases gradually. When the main power transistor is turned off, the inductor L01 discharges, and the energy stored in the inductor L01 flows to the capacitor C01 through the freewheeling diode D01. The control module applies the control signal to the third terminal of the main power transistor Q01 to intermittently control the turn-on and turn-off times of the main power transistor Q01, so that a voltage at the capacitor C01 rises gradually to the target voltage HV, which is supplied to the driving circuit. The driving circuit includes a first switch S1 and a second switch S2. The first switch S1 and the second switch S2 are turned on alternately, so that the output end of the driving circuit outputs the driving signal to the driving electrode TX.

In the signal generation circuit shown in FIG. 1, the main power transistor Q01, the freewheeling diode D01 and the capacitor C01 are all required to have a high withstand voltage, that is, the withstand voltage of each of the main power transistor Q01, the freewheeling diode D01 and the capacitor C01 needs to be higher than HV. The higher the withstand voltage of a device, the larger the package size of the device, and correspondingly the higher the device cost. In addition, a high withstand voltage requirement also limits device selection. Therefore, the design and application costs of the signal generation circuit shown in FIG. 1 are relatively high.

In addition, in the signal generation circuit shown in FIG. 1, the Boost circuit is used to boost a low DC power supply voltage to the target voltage with a high voltage gain. As is known to those skilled in the art, for the Boost circuit, the higher the voltage gain, the greater the various losses such as the conduction loss of the main power transistor and the freewheeling diode in the Boost circuit, and the lower the boosting efficiency of the Boost circuit (i.e., an energy conversion efficiency between the input and output of the Boost circuit). Moreover, in active stylus applications, the load is a small capacitive load (i.e., a small capacitance), and the current flowing through the load is usually extremely low, which further reduces the boosting efficiency of the Boost circuit. For example, in an active stylus application, the Boost circuit boosts a power supply voltage of 3.6 V to a target voltage of 60 V, and the boosting efficiency of the Boost circuit is only 40%-60%.

To this end, embodiments of the present disclosure provide a signal generation circuit. The signal generation circuit adopts a voltage boost circuit and a charge pump to increase a power supply voltage to a target voltage through two-stage voltage boosting, and supplies the target voltage to a driving circuit. The driving circuit generates a driving signal based on the target voltage, so that the withstand voltage requirement on devices in the signal generation circuit is reduced while the operating efficiency is improved, thereby realizing a signal generation circuit having low design and application costs and high efficiency.

Specific implementations of the embodiments of the present disclosure are further described below in conjunction with the accompanying drawings in the embodiments of the present disclosure.

FIG. 2 illustrates a schematic structural diagram of a signal generation circuit provided by an embodiment of the present disclosure. As shown in FIG. 2, the signal generation circuit 200 includes a voltage boost circuit 202, a charge pump 204, and a driving circuit 206.

An input end of the voltage boost circuit 202 is connected to a power supply 100, an output end of the voltage boost circuit 202 is connected to an input end of the charge pump 204, and an output end of the charge pump 204 is connected to the driving circuit 206.

The voltage boost circuit 202 is configured to boost a power supply voltage V provided by the power supply 100 to a preset voltage V1.

The charge pump 204 is configured to increase the preset voltage V1 by a preset integer multiple to generate a target voltage HV.

The driving circuit 206 is configured to receive the target voltage HV, and generate a driving signal at least based on the target voltage HV.

The power supply 100 may be a battery. For example, in active stylus applications, the power supply may be a battery of the active stylus.

The input end of the voltage boost circuit 202 is connected to the power supply 100 to receive the power supply voltage V provided by the power supply 100. The voltage boost circuit 202 may be an energy storage and release circuit composed of an inductor and a switching element. When the switching element is turned on, the inductor stores energy; when the switching element is turned off, the inductor releases energy and provides the preset voltage, which is higher than the power supply voltage.

The voltage boost circuit 202 may gradually adjust the power supply voltage V to the preset voltage V1 through energy storage and release of the inductor. In an implementation of the present disclosure, the voltage boost circuit 202 is a Boost circuit, and the structure of the voltage boost circuit may be similar to that of the Boost circuit shown in FIG. 1, detailed description thereof will be omitted herein.

The charge pump 204 achieves voltage boost by utilizing a charging and discharging principle of the capacitor. In this embodiment, the charge pump 204 may increase the preset voltage by the preset integer multiple to generate the target voltage. The preset integer multiple may be any one of 2, 4 or 6. That is, the charge pump 204 may be any one of a 2× voltage-multiplying charge pump, a 4× voltage-multiplying charge pump, or a 6× voltage-multiplying charge pump. When the preset integer multiple is 2, the voltage boost circuit 202 needs to boost the power supply voltage to ½ of the target voltage, that is, the preset voltage is equal to ½ of the target voltage. Similarly, when the preset integer multiple is 4, the voltage boost circuit 202 needs to boost the power supply voltage to ¼ of the target voltage, that is, the preset voltage is equal to ¼ of the target voltage. When the preset integer multiple is 6, the voltage boost circuit 202 needs to boost the power supply voltage to ⅙ of the target voltage, that is, the preset voltage is equal to ⅙ of the target voltage.

As the voltage multiplication factor achievable by the charge pump 204 increases, more energy storage capacitors are required in the charge pump, that is, the number of capacitors in the charge pump increases, and the efficiency of the charge pump may decrease accordingly. Therefore, in an implementation of the present disclosure, the preset integer multiple is 2. That is, the charge pump adopts a 2× voltage-multiplying charge pump. Typically, under light load conditions (i.e., a low load ratio), the efficiency of the 2× voltage-multiplying charge pump is higher than 90%.

The output end of the charge pump 204 is connected to the driving circuit 206 to supply the target voltage to the driving circuit, and the driving circuit generates the driving signal at least based on the target voltage.

In embodiments of the present disclosure, the voltage boost circuit serves as a first-stage boost to increase the power supply voltage to the preset voltage, and the charge pump serves as a second-stage boost to further increase the preset voltage to the target voltage for supply to the driving circuit. By adopting the voltage boost circuit and the charge pump to implement two-stage voltage boosting, the withstand voltage requirement on devices in the voltage boost circuit and the charge pump is greatly reduced, compared with the solution using only single-stage voltage boosting, thereby lowering the overall design and application costs of the signal generation circuit provided by the present disclosure. In addition, since an output voltage of the voltage boost circuit is the preset voltage lower than the target voltage, a voltage multiplication factor of the voltage boost circuit may be relatively low. The lower the voltage multiplication factor of the voltage boost circuit, the smaller its loss. Accordingly, the boosting efficiency of the voltage boost circuit is improved. Meanwhile, the charge pump features low path loss and high efficiency. Therefore, the signal generation circuit provided by the present disclosure may achieve both low costs and high efficiency.

For example, for an active stylus application with a power supply voltage of 3.6 V and a target voltage of 60 V, when the voltage boost circuit adopts the Boost circuit shown in FIG. 1 and the charge pump is a 2× voltage-multiplying charge pump, the voltage boost circuit only needs to increase the power supply voltage of 3.6 V to 30 V, and then the charge pump increases the preset voltage of 30 V by a factor of 2 to 60 V. Since the efficiency of the Boost circuit is related to its voltage gain, boosting the power supply voltage from 3.6 V to 30 V corresponds to a voltage gain of 8.3, while boosting the power supply voltage from 3.6 V to 60 V corresponds to a voltage gain of 16.7. The efficiency at a voltage gain of 16.7 is lower than the efficiency at a voltage gain of 8.3, with a typical difference of about 20%. Therefore, in this embodiment, the Boost circuit boosts the power supply voltage of 3.6 V to 30 V, which may increase the efficiency of the Boost circuit from 40%-60% to 60%-80%. Meanwhile, under light load conditions, the efficiency of the 2× voltage-multiplying charge pump is higher than 90%. Accordingly, the overall efficiency of the two stages may reach more than 54%-73%, which is significantly higher than the solution of direct boosting by the Boost circuit shown in FIG. 1 (i.e., 40%-60%). At the same time, due to the adoption of two-stage voltage boosting, the withstand voltage requirement on at least part of the devices in the Boost circuit and the 2× voltage-multiplying charge pump is reduced from higher than 60 V to higher than 30 V. That is, the withstand voltage requirement on the devices is greatly reduced, thereby lowering device costs and expanding the range of device selection, and further reducing the design and application costs of the entire signal generation circuit.

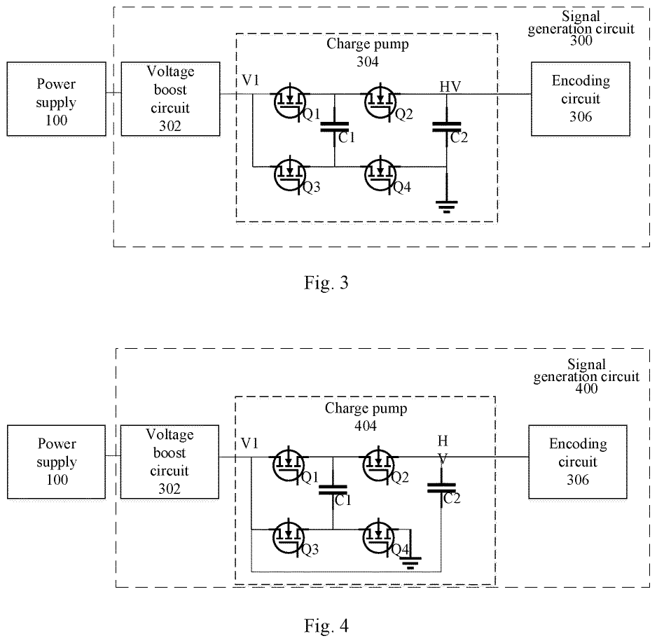

Based on the signal generation circuit shown in FIG. 2, FIG. 3 illustrates a circuit structural diagram of a signal generation circuit provided by an embodiment of the present disclosure. In the signal generation circuit 300 shown in FIG. 3, the structure and working principle of a voltage boost circuit 302 and a driving circuit 306 are the same as those of the voltage boost circuit 202 and the driving circuit 206 in the signal generation circuit 200 shown in FIG. 2. The signal generation circuit 300 shown in FIG. 3 provides a circuit implementation of the charge pump in the signal generation circuit 200 as shown in FIG. 2.

As shown in FIG. 3, a charge pump 304 includes a first capacitor C1, a second capacitor C2, a first switching transistor Q1, a second switching transistor Q2, a third switching transistor Q3, and a fourth switching transistor Q4. The first switching transistor Q1 and the second switching transistor Q2 are connected in series between an output end of the voltage boost circuit 302 and an input end of the driving circuit 306. The third switching transistor Q3 and the fourth switching transistor Q4 are connected in series between the output end of the voltage boost circuit 302 and the ground. A first terminal of the first capacitor C1 is connected to a common terminal of the first switching transistor Q1 and the second switching transistor Q2, and a second terminal of the first capacitor C1 is connected to a common terminal of the third switching transistor Q3 and the fourth switching transistor Q4. A first terminal of the second capacitor C2 is connected to the input end of the driving circuit 306, and a second terminal of the second capacitor C2 is grounded.

In this embodiment, the first switching transistor Q1 and the fourth switching transistor Q4 form a set of switches, and the second switching transistor Q2 and the third switching transistor Q3 form another set of switches. The two sets of switches may be turned on or off in a mutually exclusive manner at a certain frequency. In particular, control terminals of the first switching transistor Q1 to the fourth switching transistor Q4 are connected to a control module (not shown). The control module may turn on or off the set of switches composed of the first switching transistor Q1 and the fourth switching transistor Q4 and the set of switches composed of the second switching transistor Q2 and the third switching transistor Q3 in a mutually exclusive manner at a certain frequency, so that the charge pump 304 may boost the received preset voltage V1 to HV, where V1=0.5 HV. In this embodiment, each of the first switching transistor Q1 to the fourth switching transistor Q4 may be a field effect transistor. The control module may include a microcontroller (not shown) and a driving module (not shown). The driving module is connected to the control terminals of the first switching transistor Q1 to the fourth switching transistor Q4, and configured to drive the first switching transistor Q1 to the fourth switching transistor Q4. The microcontroller is connected to the driving module and controls the driving mode thereof, such that the driving module generates a square wave with a predetermined duty cycle to control the turn-on and turn-off of the first switching transistor Q1 to the fourth switching transistor Q4.

In this embodiment, when the first switching transistor Q1 and the fourth switching transistor Q4 are turned on while the second switching transistor Q2 and the third switching transistor Q3 are turned off, the voltages at the two terminals of the first capacitor C1 are 0.5 HV and 0 V respectively, and a voltage difference across the second switching transistor Q2 and the third switching transistor Q3 is 0.5 HV at this time. Subsequently, when the second switching transistor Q2 and the third switching transistor Q3 are turned on while the first switching transistor Q1 and the fourth switching transistor Q4 are turned off, the voltages at the two terminals of the first capacitor C1 are HV and 0.5 HV respectively, and a voltage difference across the first switching transistor Q1 and the fourth switching transistor Q4 is only 0.5 HV at this time. That is, during the whole operation procedure, the withstand voltage of the first switching transistor Q1, the second switching transistor Q2, the third switching transistor Q3, the fourth switching transistor Q4 and the first capacitor C1 only needs to satisfy 0.5 HV. Compared with the single-stage boosting solution in the signal generation circuit shown in FIG. 1, the devices do not need to withstand the high voltage HV, which reduces the requirement on the devices, while lowering the circuit design cost of the signal generation circuit.

In the charge pump 304 shown in FIG. 3, the withstand voltage of the second capacitor C2 needs to satisfy HV. To optimize the withstand voltage of the second capacitor C2, FIG. 4 provides a schematic structural diagram of a signal generation circuit according to an embodiment of the present disclosure. The signal generation circuit 400 shown in FIG. 4 differs from the signal generation circuit 300 shown in FIG. 3 in the circuit implementation of the charge pump.

In the signal generation circuit 400 shown in FIG. 4, a charge pump 404 includes a first capacitor C1, a second capacitor C2, a first switching transistor Q1, a second switching transistor Q2, a third switching transistor Q3, and a fourth switching transistor Q4. The first switching transistor Q1 and the second switching transistor Q2 are connected in series between the output end of the voltage boost circuit 302 and the input end of the driving circuit 306. The third switching transistor Q3 and the fourth switching transistor Q4 are connected in series between the output end of the voltage boost circuit 302 and the ground. A first terminal of the first capacitor C1 is connected to a common terminal of the first switching transistor Q1 and the second switching transistor Q2, and a second terminal of the first capacitor C1 is connected to a common terminal of the third switching transistor Q3 and the fourth switching transistor Q4. A first terminal of the second capacitor C2 is connected to the input end of the driving circuit 306, and a second terminal of the second capacitor C2 is connected to the output end of the voltage boost circuit 302.

In this embodiment, the control process and working principle of the charge pump 400 are the same as those of the charge pump 300 in the embodiment shown in FIG. 3. The only difference lies in that the second terminal of the second capacitor C2 is connected to the output end of the voltage boost circuit 302 in FIG. 4, so that the withstand voltage of the second capacitor C2 is also reduced from HV to 0.5 HV. That is, in the embodiment shown in FIG. 4, the withstand voltage of all devices in the charge pump only needs to meet 0.5 HV. Compared with the single-stage boosting solution in the signal generation circuit shown in FIG. 1, none of the devices need to withstand the high voltage HV, which reduces the withstand voltage requirement on the devices, while lowering the circuit design cost of the signal generation circuit.

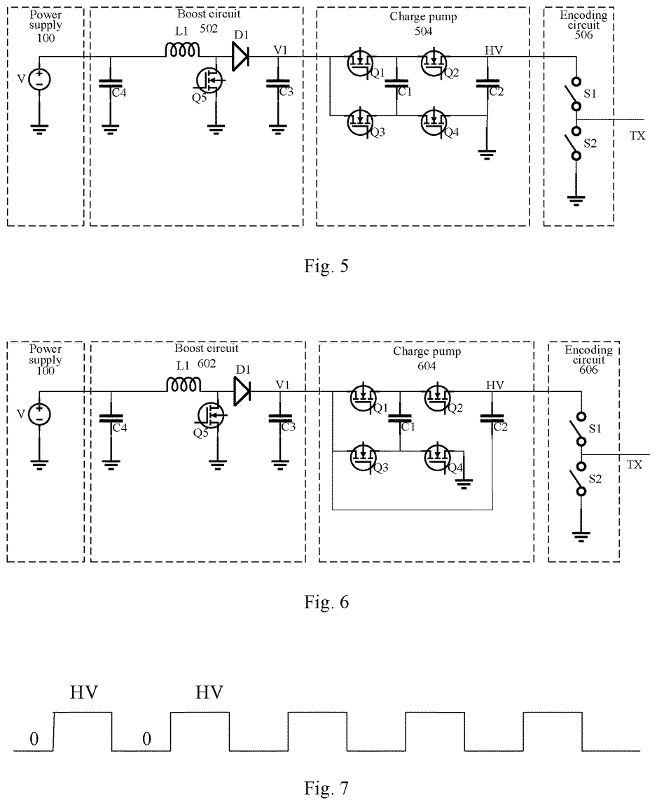

In the signal generation circuits shown in FIG. 2 to FIG. 4, each voltage boost circuit may include a Boost circuit. As shown in FIG. 5 and FIG. 6, the voltage boost circuits are respectively a Boost circuit 502 and a Boost circuit 602. Each of the Boost circuit 502 and the Boost circuit 602 includes an inductor L1, a switching transistor Q5, a freewheeling diode D1, and a third capacitor C3. A first terminal of the inductor L1 is connected to the power supply 100, and a second terminal of the inductor L1 is connected to a first terminal of the switching transistor Q5 and the anode of the freewheeling diode D1. A second terminal of the switching transistor Q5 is connected to the ground, and a third terminal of the switching transistor Q5 is connected to a control module (not shown) to receive a control signal. The cathode of the freewheeling diode D1 is connected to the input end of the charge pump 504 and 604, and to a first terminal of the third capacitor C3. A second terminal of the third capacitor C3 is connected to the ground.

In this embodiment, the switching transistor Q5 may be a field effect transistor. The control module connected to the switching transistor Q5 may be the control module in the embodiments shown in FIG. 3 and FIG. 4. The control module intermittently controls the turn-on and turn-off of the switching transistor Q5, and by controlling the number of turn-on and turn-off times of the switching transistor Q5, the voltage across the third capacitor C3 may be increased to V1, where V1=0.5 HV. The freewheeling diode D1 may prevent the energy on the third capacitor C3 from flowing back to the power supply. The specific boosting process of the Boost circuit in this embodiment may refer to the process of the Boost circuit shown in FIG. 1, and detailed description thereof will be omitted herein.

Since the voltage boost circuit in this embodiment only needs to boost the power supply voltage V to 0.5 HV, devices such as the switching transistor Q5, the freewheeling diode D1 and the third capacitor C3 in the Boost circuit only need to meet the voltage requirement of 0.5 HV. Compared with the single-stage boosting solution in the signal generation circuit shown in FIG. 1, the devices do not need to withstand the high voltage HV, which reduces the requirement on the devices, while lowering the circuit design cost of the signal generation circuit.

The embodiments shown in FIG. 5 and FIG. 6 further illustrate circuit structural diagrams of a driving circuit provided according to an embodiment of the present disclosure. As shown in FIG. 5 and FIG. 6, each of a driving circuit 506 and 606 includes a switch module and a control module (not shown) connected to a control end of the switch module. The switch module includes a first switch S1 and a second switch S2. The first switch S1 and the second switch S2 are connected in series between the output end of the charge pump 504 and 604 and the ground. A common terminal between the first switch S1 and the second switch S2 is connected to an output end of the driving circuit 506 and 606.

The control module (not shown) is configured to control states of switches in the switch module, so that the output end of the driving circuit 506 and 606 outputs the driving signal, where the driving signal includes two levels of voltage whose amplitudes are a ground voltage and the target voltage.

The control module in this embodiment may be designed to be integrated with the control module that controls each switching transistor in the voltage boost circuit and the charge pump, or may be designed independently of the control module that controls each switching transistor in the voltage boost circuit and the charge pump, which is not limited in this embodiment.

In a specific implementation, the control of the switches in the switch module by the control module includes a first phase and a second phase;
in the first phase, the first switch S1 is in a closed state and the second switch S2 is in an open state, and the output end of the driving circuit 506 and 606 outputs the target voltage; and
in the second phase, when the first switch S1 is in an open state and the second switch S2 is in a closed state, the output end of the driving circuit 506 and 606 outputs the ground voltage.

The control module periodically executes the first phase and the second phase according to the above method, so as to simply control and generate the driving signal as shown in FIG. 7, where 0 represents the ground voltage and HV represents the target voltage.

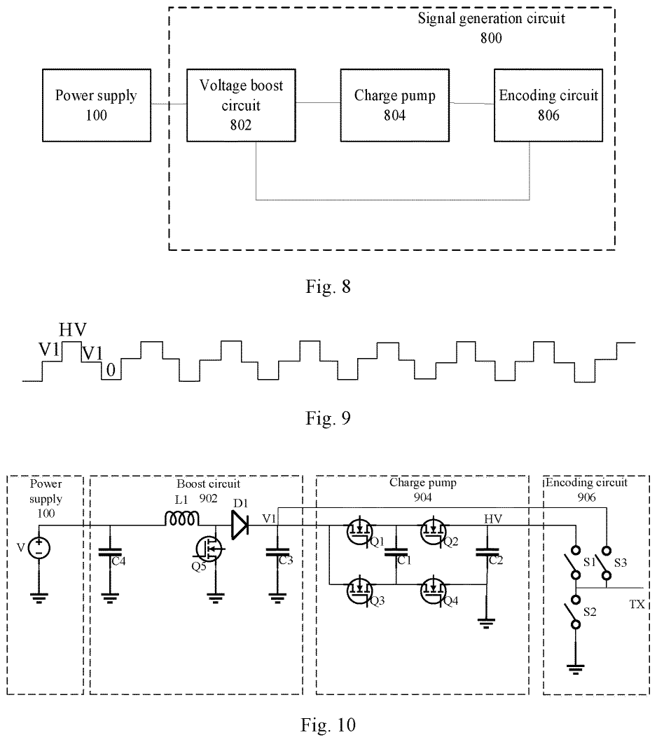

In an active stylus application, the load is a capacitive load, and energy loss inevitably occurs when charging the capacitive load. The energy loss is proportional to the square of a charging voltage difference. To reduce the loss of the driving signal during charging the capacitive load and improve an encoding efficiency, a signal generation circuit as shown in FIG. 8 is provided. The signal generation circuit shown in FIG. 8 differs from the signal generation circuits shown in FIG. 2 to FIG. 7 in that a driving circuit 806 in the signal generation circuit shown in FIG. 8 includes a first input end and a second input end. The first input end of the driving circuit 806 is connected to the output end of the charge pump 804, and the second input end of the driving circuit 806 is connected to the output end of the voltage boost circuit 802. The driving circuit is configured to receive the preset voltage output by the voltage boost circuit and the target voltage output by the charge pump, and generate the driving signal based on the preset voltage and the target voltage. the driving signal is a stepped signal and includes three levels of voltage whose amplitudes are a ground voltage, the preset voltage and the target voltage.

In this embodiment, the structure and working principle of the voltage boost circuit 802 and the charge pump 804 are the same as those of the voltage boost circuit and the charge pump in the embodiments shown in FIG. 2 to FIG. 6, and detailed description thereof will be omitted herein.

In this embodiment, by connecting the first input end of the driving circuit 806 to the output end of the charge pump 804 and connecting the second input end of the driving circuit 806 to the output end of the voltage boost circuit 802, the driving circuit may generate the stepped encoding signal as shown in FIG. 9. For the capacitive load, the lower the single charging voltage, the smaller the power loss. In particular, the energy loss is proportional to the square of the charging voltage difference. Therefore, compared with the driving signal shown in FIG. 7, the voltage difference between two levels of voltage of the stepped encoding signal shown in FIG. 9 is greatly reduced, so that the energy loss is significantly reduced, thereby improving the encoding efficiency. For example, when the preset voltage is 0.5 times the target voltage, the stepped encoding signal shown in FIG. 9 may save 50% of energy and achieve higher encoding efficiency.

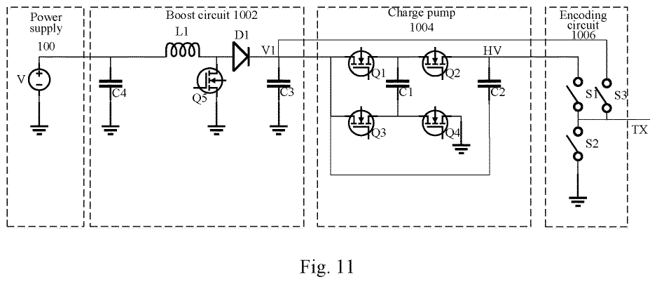

FIG. 10 and FIG. 11 illustrate two schematic structural diagrams of a signal generation circuit provided according to an embodiment of the present disclosure. The structure and working principle of the Boost circuit and the charge pump in FIG. 10 and FIG. 11 are the same as those of the Boost circuit and the charge pump in the foregoing embodiments, and detailed description thereof will be omitted herein. The signal generation circuits shown in FIG. 10 and FIG. 11 differ from the signal generation circuits in the foregoing embodiments in the structure of the driving circuit. In particular, as shown in FIG. 10 and FIG. 11, each of the driving circuit 906 and 1006 includes a switch module and a control module connected to a control terminal of the switch module; the switch module includes a first switch S1, a second switch S2 and a third switch S3, the first switch S1 and the second switch S2 are connected in series between the output end of the charge pump 904 and 1004 and the ground, a common terminal between the first switch S1 and the second switch S2 is connected to an output end of the driving circuit 906 and 1006, a first terminal of the third switch S3 is connected to the output end of the voltage boost circuit 902 and 1002, and a second terminal of the third switch S3 is connected to the output end of the driving circuit 906 and 1006. The control module (not shown) is configured to control states of switches in the switch module, so that the output end of the driving circuit 906 and 1006 outputs the driving signal.

The control module in this embodiment may be designed to be integrated with the control module that controls each switching transistor in the Boost circuit and the charge pump, or may be designed independently of the control module that controls each switching transistor in the Boost circuit and the charge pump, which is not limited in this embodiment.

In a specific implementation, the control of the switches in the switch module by the control module includes a first phase, a second phase, a third phase and a fourth phase;
in the first phase, the third switch S3 is in a closed state, and the first switch S1 and the second switch S2 are in an open state, an output end of the driving circuit 906 and 1006 outputs the preset voltage;
in the second phase, the first switch S1 is in a closed state, and the second switch S2 and the third switch S3 are in an open state, the output end of the driving circuit 906 and 1006 outputs the target voltage;
in the third phase, the third switch S3 is in a closed state, and the first switch S1 and the second switch S2 are in an open state, the output end of the driving circuit 906 and 1006 outputs the preset voltage; and
in the fourth phase, the second switch S2 is in a closed state, and the first switch S1 and the third switch S3 are in an open state, the output end of the driving circuit 906 and 1006 outputs the ground voltage.

In this embodiment, the control module controls the turn-on and turn-off of the first switch S1, the second switch S2 and the third switch S3 in this way to implement the stepped encoding signal shown in FIG. 9. For the capacitive load, the energy loss is proportional to the square of the charging voltage difference. Therefore, compared with the driving signal shown in FIG. 7, the voltage difference between two levels of voltage of the stepped encoding signal shown in FIG. 9 is greatly reduced, so that the energy loss is significantly reduced, thereby improving the encoding efficiency.

Embodiments of the present disclosure provide a touch controller chip, including the signal generation circuit according to any one of embodiments of the present disclosure.

Embodiments of the present disclosure further provide an active stylus, including the touch controller chip provided in the foregoing embodiment. When the active stylus is in contact with a capacitive touch screen of a terminal device, the touch controller chip provides a driving signal for a nib of the active stylus.

Terminal devices according to the embodiments of the present disclosure may be implemented in various forms, including but not limited to the following categories:
(1) Mobile communication devices: Such devices feature a mobile communication function and are mainly intended for providing voice and data communication services. Such terminals include smartphones (such as iPhone), multimedia mobile phones, feature phones, and entry-level mobile phones.
(2) Ultra-mobile personal computer devices: Such devices fall into the category of personal computers, have computing and processing functions, and generally support mobile internet access. Such terminals include PDAs, MIDs, and UMPC devices, such as iPad.
(3) Portable entertainment devices: Such devices may display and play multimedia content. Such devices include audio and video players (such as iPod), handheld game consoles, electronic books, smart toys, and portable vehicle navigation devices.
(4) Servers: Devices configured to provide computing services. A server includes a processor 810, a hard disk, a memory, a system bus, and the like, and adopts an architecture similar to that of a general-purpose computer. However, to provide high-reliability services, servers impose higher requirements on processing capability, stability, reliability, security, scalability, and manageability.
(5) Other electronic apparatuses having a data interaction function.

To this end, specific embodiments of the present disclosure have been described. Other embodiments fall within the scope of the appended claims. In some cases, the operations recited in the claims may be performed in a different order while still achieving the desired results. In addition, the processes illustrated in the accompanying drawings are not necessarily limited to the specific order or sequential order as shown to achieve the desired results. In certain embodiments, multi-tasking and parallel processing may be adopted advantageously.

The embodiments in this specification are described in a progressive manner. Identical or similar parts among the various embodiments may be referred to each other, and each embodiment focuses on the differences from other embodiments. In particular, as system embodiments are substantially similar to method embodiments, they are described briefly, and relevant parts may refer to the descriptions of the method embodiments.

The foregoing are merely embodiments of the present disclosure, and are not intended to limit the present disclosure. Various modifications and variations may be made by those skilled in the art without departing from the spirit and principle of the present disclosure. Any modification, equivalent replacement, improvement and the like made within the spirit and principle of the present disclosure shall fall within the scope of the claims of the present disclosure.

1. A signal generation circuit, comprising: a voltage boost circuit, a charge pump, and a driving circuit;
wherein an input end of the voltage boost circuit is connected to a power supply, an output end of the voltage boost circuit is connected to an input end of the charge pump, and an output end of the charge pump is connected to the driving circuit;
the voltage boost circuit is configured to boost a power supply voltage provided by the power supply to a preset voltage;
the charge pump is configured to increase the preset voltage by a preset integer multiple to generate a target voltage; and
the driving circuit is configured to receive the target voltage, and generate a driving signal at least based on the target voltage.

2. The signal generation circuit according to claim 1, wherein the preset integer multiple is 2.

3. The signal generation circuit according to claim 2, wherein the charge pump comprises a first capacitor, a second capacitor, a first switch transistor, a second switch transistor, a third switch transistor, and a fourth switch transistor;
the first switch transistor and the second switch transistor are connected in series between the output end of the voltage boost circuit and a first input end of the driving circuit, the third switch transistor and the fourth switch transistor are connected in series between the output end of the voltage boost circuit and ground; and
a first terminal of the first capacitor is connected to a common terminal of the first switch transistor and the second switch transistor, a second terminal of the first capacitor is connected to a common terminal of the third switch transistor and the fourth switch transistor; and
a first terminal of the second capacitor is connected to the first input end of the driving circuit, and a second terminal of the second capacitor is grounded.

4. The signal generation circuit according to claim 2, wherein the charge pump comprises a first capacitor, a second capacitor, a first switch transistor, a second switch transistor, a third switch transistor and a fourth switch transistor;
the first switch transistor and the second switch transistor are connected in series between the output end of the voltage boost circuit and a first input end of the driving circuit, the third switch transistor and the fourth switch transistor are connected in series between the output end of the voltage boost circuit and ground;
a first terminal of the first capacitor is connected to a common terminal of the first switch transistor and the second switch transistor, a second terminal of the first capacitor is connected to a common terminal of the third switch transistor and the fourth switch transistor; and
a first terminal of the second capacitor is connected to an input end of the driving circuit, and a second terminal of the second capacitor is connected to the output end of the voltage boost circuit.

5. The signal generation circuit according to claim 1, wherein the voltage boost circuit comprises a Boost circuit.

6. The signal generation circuit according to claim 1, wherein the driving circuit comprises a switch module and a control module connected to a control terminal of the switch module;
the switch module comprises a first switch and a second switch, the first switch and the second switch are connected in series between the output end of the charge pump and ground, and a common terminal between the first switch and the second switch is connected to an output end of the driving circuit; and
the control module is configured to control states of switches in the switch module, so that the output end of the driving circuit outputs the driving signal, wherein the driving signal comprises two levels of voltage whose amplitudes are a ground voltage and the target voltage.

7. The signal generation circuit according to claim 6, wherein the control of the switches in the switch module by the control module comprises a first phase and a second phase;
in the first phase, the first switch is in a closed state and the second switch is in an open state, and the output end of the driving circuit outputs the target voltage; and
in the second phase, when the first switch is in an open state and the second switch is in a closed state, the output end of the driving circuit outputs the ground voltage.

8. The signal generation circuit according to claim 1, wherein the driving circuit comprises a first input end and a second input end, the first input end of the driving circuit is connected to the output end of the charge pump, and the second input end of the driving circuit is connected to the output end of the voltage boost circuit; and
the driving circuit is configured to receive the preset voltage and the target voltage, and generate the driving signal based on the preset voltage and the target voltage, wherein the driving signal is a stepped signal and comprises three levels of voltage whose amplitudes are a ground voltage, the preset voltage and the target voltage.

9. The signal generation circuit according to claim 8, wherein the driving circuit comprises a switch module and a control module connected to a control terminal of the switch module;
the switch module comprises a first switch, a second switch and a third switch, the first switch and the second switch are connected in series between the output end of the charge pump and ground, a common terminal between the first switch and the second switch is connected to an output end of the driving circuit, a first terminal of the third switch is connected to the output end of the voltage boost circuit, and a second terminal of the third switch is connected to the output end of the driving circuit; and
the control module is configured to control states of switches in the switch module, so that the output end of the driving circuit outputs the driving signal.

10. The signal generation circuit according to claim 8, wherein the control of the switches in the switch module by the control module comprises a first phase, a second phase, a third phase and a fourth phase;
in the first phase, the third switch is in a closed state, and the first switch and the second switch are in an open state, an output end of the driving circuit outputs the preset voltage;
in the second phase, the first switch is in a closed state, and the second switch and the third switch are in an open state, the output end of the driving circuit outputs the target voltage;
in the third phase, the third switch is in a closed state, and the first switch and the second switch are in an open state, the output end of the driving circuit outputs the preset voltage; and
in the fourth phase, the second switch is in a closed state, and the first switch and the third switch are in an open state, the output end of the driving circuit outputs the ground voltage.

11. A touch controller chip, comprising a signal generation circuit, the signal generation circuit comprising: a voltage boost circuit, a charge pump, and a driving circuit;
wherein an input end of the voltage boost circuit is connected to a power supply, an output end of the voltage boost circuit is connected to an input end of the charge pump, and an output end of the charge pump is connected to the driving circuit;
the voltage boost circuit is configured to boost a power supply voltage provided by the power supply to a preset voltage;
the charge pump is configured to increase the preset voltage by a preset integer multiple to generate a target voltage; and
the driving circuit is configured to receive the target voltage, and generate a driving signal at least based on the target voltage.

12. The touch controller chip according to claim 11, wherein the preset integer multiple is 2.

13. The touch controller chip according to claim 12, wherein the charge pump comprises a first capacitor, a second capacitor, a first switch transistor, a second switch transistor, a third switch transistor, and a fourth switch transistor;
the first switch transistor and the second switch transistor are connected in series between the output end of the voltage boost circuit and a first input end of the driving circuit, the third switch transistor and the fourth switch transistor are connected in series between the output end of the voltage boost circuit and ground; and
a first terminal of the first capacitor is connected to a common terminal of the first switch transistor and the second switch transistor, a second terminal of the first capacitor is connected to a common terminal of the third switch transistor and the fourth switch transistor; and
a first terminal of the second capacitor is connected to the first input end of the driving circuit, and a second terminal of the second capacitor is grounded.

14. The touch controller chip according to claim 12, wherein the charge pump comprises a first capacitor, a second capacitor, a first switch transistor, a second switch transistor, a third switch transistor and a fourth switch transistor;
the first switch transistor and the second switch transistor are connected in series between the output end of the voltage boost circuit and a first input end of the driving circuit, the third switch transistor and the fourth switch transistor are connected in series between the output end of the voltage boost circuit and ground;
a first terminal of the first capacitor is connected to a common terminal of the first switch transistor and the second switch transistor, a second terminal of the first capacitor is connected to a common terminal of the third switch transistor and the fourth switch transistor; and
a first terminal of the second capacitor is connected to an input end of the driving circuit, and a second terminal of the second capacitor is connected to the output end of the voltage boost circuit.

15. The touch controller chip according to claim 11, wherein the voltage boost circuit comprises a Boost circuit.

16. The touch controller chip according to claim 11, wherein
the driving circuit comprises a switch module and a control module connected to a control terminal of the switch module;
the switch module comprises a first switch and a second switch, the first switch and the second switch are connected in series between the output end of the charge pump and ground, and a common terminal between the first switch and the second switch is connected to an output end of the driving circuit; and
the control module is configured to control states of switches in the switch module, so that the output end of the driving circuit outputs the driving signal, wherein the driving signal comprises two levels of voltage whose amplitudes are a ground voltage and the target voltage; or.
the driving circuit comprises a first input end and a second input end, the first input end of the driving circuit is connected to the output end of the charge pump, and the second input end of the driving circuit is connected to the output end of the voltage boost circuit; and
the driving circuit is configured to receive the preset voltage and the target voltage, and generate the driving signal based on the preset voltage and the target voltage, wherein the driving signal is a stepped signal and comprises three levels of voltage whose amplitudes are a ground voltage, the preset voltage and the target voltage.

17. The touch controller chip according to claim 16, wherein the control of the switches in the switch module by the control module comprises a first phase and a second phase;
in the first phase, the first switch is in a closed state and the second switch is in an open state, and the output end of the driving circuit outputs the target voltage; and
in the second phase, when the first switch is in an open state and the second switch is in a closed state, the output end of the driving circuit outputs the ground voltage.

18. The touch controller chip according to claim 11, wherein the driving circuit comprises a first input end and a second input end, the first input end of the driving circuit is connected to the output end of the charge pump, and the second input end of the driving circuit is connected to the output end of the voltage boost circuit; and
the driving circuit is configured to receive the preset voltage and the target voltage, and generate the driving signal based on the preset voltage and the target voltage, wherein the driving signal is a stepped signal and comprises three levels of voltage whose amplitudes are a ground voltage, the preset voltage and the target voltage.

19. The touch controller chip according to claim 16, wherein the driving circuit comprises a switch module and a control module connected to a control terminal of the switch module;
the switch module comprises a first switch, a second switch and a third switch, the first switch and the second switch are connected in series between the output end of the charge pump and ground, a common terminal between the first switch and the second switch is connected to an output end of the driving circuit, a first terminal of the third switch is connected to the output end of the voltage boost circuit, and a second terminal of the third switch is connected to the output end of the driving circuit; and
the control module is configured to control states of switches in the switch module, so that the output end of the driving circuit outputs the driving signal.

20. An active stylus, comprising the touch controller chip according to claim 11.
